(19) United States
(12) Patent Application Publication
(10) Pub. No.: US 2009/0148290 A1
(43) Pub. Date: Jun. 11, 2009

(54) WIND TURBINE AND METHOD OF OPERATING SAME

(76) Inventor: Theodore M. Garver, Springboro, PA (US)

Correspondence Address: Fay Sharpe LLP, 1228 Euclid Avenue, 5th Floor, The Halle Building, Cleveland, OH, 44115, US

(21) Appl. No.: 12/372,371

(22) Filed: Feb. 17, 2009

Related U.S. Application Data
(63) Continuation-in-part of application No. 12/157,104, filed on Jun. 5, 2008.
(60) Provisional application No. 60/933,325, filed on Jun. 6, 2007.

(51) Int. Cl. F03D 1/04

(52) U.S. Cl. 416/146 R; 416/1; 416/223 R

(57) ABSTRACT

A turbine blade assembly includes a turbine blade and a moveable surface supported for lateral displacement across the turbine blade. A wind turbine include a base structure, a turbine body and a turbine blade assembly operatively connected to the turbine body. A method of operating a wind turbine is also included.

This application is a continuation-in-part of U.S. application Ser. No. 12/157,104, filed on Jun. 5, 2008, which claims the benefit of U.S. Provisional Application Ser. No. 60/933,325, filed Jun. 6, 2007, the subject matter of each of which is hereby incorporated herein by reference in its entirety.

### INCORPORATION BY REFERENCE

U.S. Pat. Nos. 6,322,024 and 6,824,109, both to the inventor of the present application, disclose the use of moving bands in connection with fixed wing aircraft. The entire disclosure of each of these documents is hereby incorporated herein by reference.

### BACKGROUND

The subject matter of the present disclosure broadly relates to the art of energy conversion systems and, more particularly, to a wind turbine capable of converting wind energy into rotational mechanical energy, such as may be used to operate a generator to produce electrical energy, for example, as well as a method of operating a wind turbine.

The subject matter of the present disclosure finds particular application and use in connection with wind turbine, and is shown and described herein with preference thereto. It will be appreciated, however, that the subject matter of the present disclosure is amenable to use in a variety of other applications and/or environments, such as air moving devices (e.g., fans) and other power generation systems (e.g., turbines), for example. As such, it is to be understood that the specific reference herein to use on and/or in association with wind turbines is merely one example of such use not intended to be limiting.

Wind turbines are well known and commonly used to convert wind energy into rotational mechanical output that can be used for any suitable purpose, such as to operate a generating system or device for the production of electrical power, for example. Current wind turbine designs typically include a base structure that supports a turbine housing at a level that is elevated with respect to the surrounding geography (i.e., land surface or water level). In many constructions, two or more turbine blades are supported on a hub of the turbine housing. The hub is capable of rotating in response to air currents (i.e., wind) that are acting on the blades. In this manner, wind energy can be converted to rotational mechanical energy for electrical power generation and/or other purposes.

Notwithstanding the overall success of modern wind turbine designs, one or more characteristics have been observed that may operate to limit the application and/or use of wind turbines. These characteristics may also reduce the overall cost effectiveness of wind turbines under certain conditions. As such, these issues may lead to a reduction in the installation and use of wind turbines, where increased installation and usage might be preferred.

One such characteristic involves the conditions of operation of wind turbines. That is, there are known to be minimum and maximum wind speed thresholds outside of which operation of a wind turbine is generally avoided. Of course, these minimum and maximum wind speed thresholds will vary from wind turbine to wind turbine and from situation to situation.

At one extreme, it is generally acknowledges that there is a minimum wind speed at which a wind turbine can effectively operate. In many cases, the minimum wind speed is within a range of from about 5 MPH to about 8 MPH. As such, wind turbines often remain idle in light wind conditions.

At the opposite extreme, it is generally recognized that there is a maximum wind speed at which a wind turbine may be operated. Often, the maximum wind speed is greater than 50 MPH. As expected, the maximum wind speed threshold will relate to the design and construction of the wind turbine as well as the operational limitations of the electrical components driven by the turbine. Nonetheless, wind turbines are commonly stopped during high wind conditions.

It is believed desirable to develop a wind turbine and method of operation that overcomes these and/or other disadvantageous characteristics of known wind turbines and that can operate under a greater range of wind speeds and/or conditions.

### BRIEF DESCRIPTION

One example of a wind turbine in accordance with the subject matter of the present disclosure can include a base structure and a turbine body that includes first and second body portions. The first body portion is supported on the base structure and includes a first axis extending longitudinally along the first body portion. The second body portion is supported on the first body portion for rotation about the first axis. A turbine blade assembly is supported on the second turbine body for rotation therewith about the first axis. The turbine blade assembly includes a turbine blade that has a longitudinal length, a first longitudinal edge, a second longitudinal edge spaced laterally from the first longitudinal edge, a first side extending longitudinally along at least a portion of the length between the first and second longitudinal edges, and a second side extending longitudinally along at least a portion of the length between the first and second longitudinal edges and generally opposite the first side. The turbine blade includes a proximal end operatively connected to the second turbine body and a distal end spaced radially-outwardly from the proximal end. A first endless band includes a first outer surface and a first band width. The first endless band is oriented such that the first band width extends longitudinally along the turbine blade. The first endless band is supported on the turbine blade such that the first outer surface is exposed along at least a portion of at least one of the first and second sides of the turbine blade and is capable of lateral movement along the at least one of the first and second sides. In this manner, a relative velocity can be maintained between the first outer surface and the at least one of the first and second sides of the turbine blade.

One example of a wind turbine blade assembly in accordance with the subject matter of the present disclosure can include a wind turbine blade and an endless band. The wind turbine blade includes a longitudinal length extending between opposing first and second ends, a first edge extending longitudinally along the blade, a second edge extending longitudinally along the blade in laterally spaced relation to the first edge, a first side extending longitudinally along the blade and laterally between the first and second edges, and a second side extending longitudinally along the blade and laterally between the first and second edges generally opposite the first side. The first endless band includes a first outer surface and a first band width. The first endless band being oriented such that the first band width extends longitudinally along the blade. The first endless band being supported on the blade such that the first outer surface is exposed along at least a portion of at least one of the first and second sides of the blade and is capable of lateral movement along the at least one of the first and second sides such that a first relative velocity can be maintained between the first outer surface and the at least one of the first and second sides of the blade.

One example of a method of operating a wind turbine in accordance with the subject matter of the present disclosure can include providing a wind turbine and providing an endless band. The wind turbine can include a base structure, a turbine body supported on the base structure and at least one turbine blade. The turbine body can have a longitudinal-extending turbine body axis, and the at least one turbine blade can be supported on the turbine body for rotation about the turbine body axis. The at least one turbine blade includes a longitudinal length extending between opposing first and second ends, a first edge extending longitudinally along the blade, a second edge extending longitudinally along the blade in laterally spaced relation to the first edge, a first side extending longitudinally along the blade and laterally between the first and second edges, and a second side extending longitudinally along the blade and laterally between the first and second edges generally opposite the first side. The endless band includes a first outer surface and a first band width. The method also includes orienting the endless band such that the first band width extends longitudinally along the blade and supporting the endless band on the blade such that the first outer surface is exposed along at least a portion of at least one of the first and second sides of the blade. The method further includes driving the at least one endless band such that the outer surface moves laterally along at least one of the first and second sides of the blade between the first and second edges thereof.

### BRIEF DESCRIPTION OF THE DRAWINGS

FIG. 1 is a front elevation view of one example of a wind turbine in accordance with the subject matter of the present disclosure.

FIG. 2 is a side elevation view of the wind turbine in FIG. 1 shown in partial cross-section.

FIG. 3 is a side view of one example of a turbine blade assembly in accordance with the subject matter of the present disclosure, such as may be included on the wind turbine in FIGS. 1 and 2.

FIG. 4 is an enlarged detail view of the portion of the turbine blade assembly shown in Detail 4 of FIG. 3.

FIG. 5 is a cross-sectional view of the turbine blade assembly in FIGS. 3 and 4 taken from along line 5-5 in FIG. 4.

FIG. 6 is a side view of another example of a turbine blade assembly in accordance with the subject matter of the present disclosure, such as may be included on the wind turbine in FIGS. 1 and 2.

FIG. 7 is an enlarged detail view of the portion of the turbine blade assembly shown in Detail 7 of FIG. 6.

FIG. 8 is a cross-sectional view of the turbine blade assembly in FIGS. 6 and 7 taken from along line 8-8 in FIG. 7.

FIG. 9 is a cross-sectional schematic representation of a further example of a turbine blade assembly in accordance with the subject matter of the present disclosure that includes a separate movable surface on each side of a turbine blade.

FIG. 10 is a graphical representation of one example of a method of operating a wind turbine in accordance with the subject matter of the present disclosure.

### DETAILED DESCRIPTION

Referring now in greater detail to the drawings, it is to be understood that the illustrations reference herein are for the purposes of demonstrating examples of embodiments of the subject matter of the present disclosure and that these illustrations and examples are not intended to be in any way limiting. Additionally, it should be recognized and appreciated that the drawings are not to scale and that the proportion of certain features and/or elements may be exaggerated for purposes of clarity and ease of understanding.

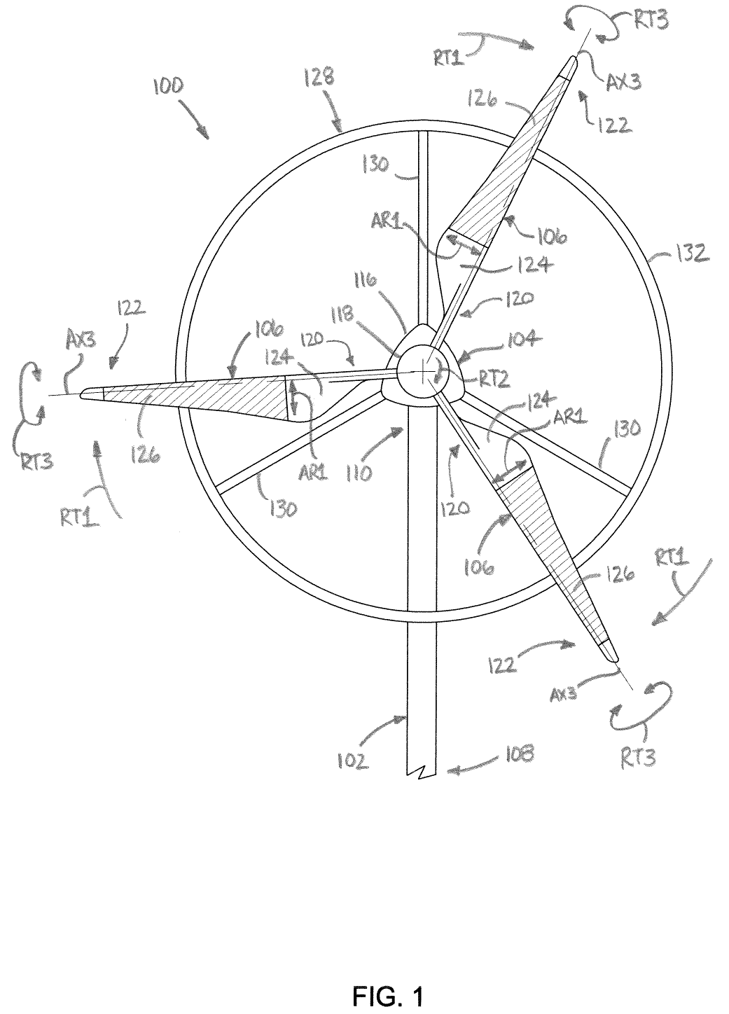

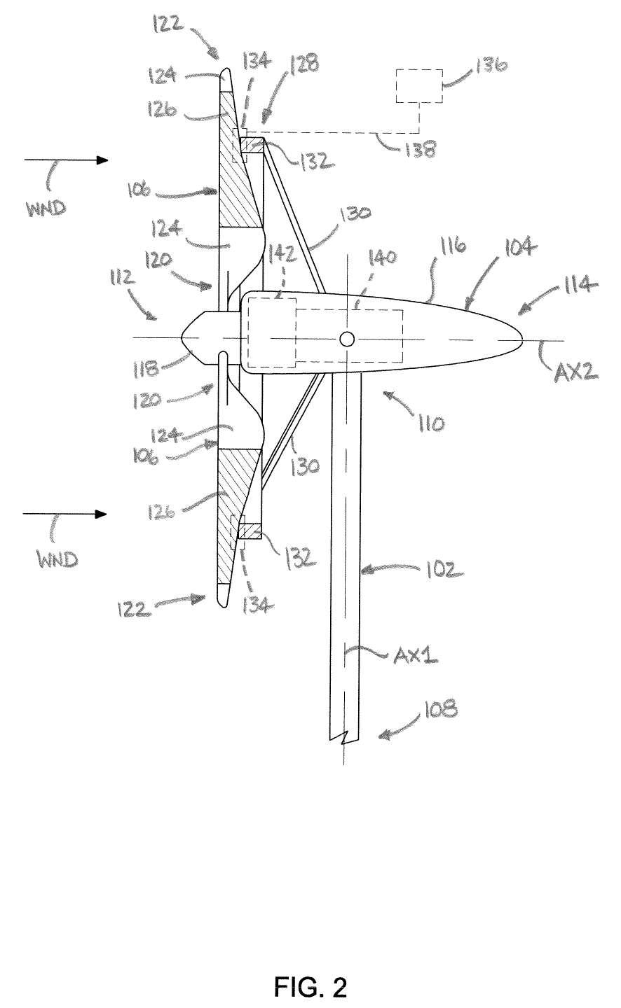

FIGS. 1 and 2 illustrate a wind turbine 100 that includes a support or base structure 102, a turbine body 104 that is supported on the base structure, and at least one turbine blade assembly that is operatively connected to the turbine body. In the exemplary embodiment shown in FIGS. 1 and 2, a plurality of turbine blade assemblies 106 is shown as being operatively connected to turbine body 104. It will be appreciated, however, that any suitable number of turbine blade assemblies can supported on the turbine body, such as from one (1) to nine (9) turbine blade assemblies, for example.

Support or base structure 102 is shown in FIGS. 1 and 2 as having an approximately-straight configuration extending longitudinally between a first or lower end 108 and a second or upper end 110. It will be appreciated that the base structure can be of any type, kind, configuration and/or construction suitable for supporting turbine body 104 and the one or more turbine blade assemblies at a suitable elevation above a supporting foundation (not shown), and that base structure 102 is merely one example of a base structure that could be used. Additionally, it will be appreciated that a wind turbine in accordance with the subject disclosure can be installed at any suitable geographic location. As such, the supporting foundation could, without limitation, be a solid foundation supported by the ground, a floating structure on a body of water or even a rooftop (or other elevated portion) of a building or other structure.

Base structure 102 is shown in FIG. 2 as including a longitudinally-extending axis AX1 extending between the first and second ends thereof. Turbine body 104 is shown as being supported on second end 110 and, in a preferred arrangement, is operatively connected to base structure 102 such that the turbine body can be rotated about axis AX1. In this manner, the turbine body and the one or more turbine blade assemblies supported thereon can be favorably oriented with respect to the direction of the wind. It will be recognized that the favorable orientation of a turbine body and one or more turbine blade assemblies of a wind turbine is generally well understood in the art and that any suitable arrangement and/or system can be used to control the orientation of the turbine body and one or more turbine blade assemblies about axis AX1.

Turbine body 104 includes a first or front end 112, a second or tail end 114 and a longitudinal axis AX2 that extends generally between front and tail ends 112 and 114. As shown in FIG. 2, turbine body 104 can be oriented in a lengthwise-direction with respect to the wind direction, as indicated by arrows WND, such that front end 112 and turbine blade assemblies 106 are facing in an upstream direction and tail end 114 is disposed in a downstream direction. It will be appreciated, however, that other configurations and/or constructions of wind turbines may operate in a different manner.

Turbine body 104 also includes a first body portion 116 that is supported on the base structure for rotation about axis AX1, as described above, and a second body portion 118 that is supported on the first body portion for rotation about axis AX2. It will be appreciated that second body portion 118 can be supported on first body portion 116 in any suitable manner, such as may be known by those of skill in the art.

With further reference to FIGS. 1 and 2, a plurality of turbine blade assemblies 106 are operatively connected to second body portion 118 of turbine body 104 for rotation therewith about axis AX2. As will be described in detail hereinafter, kinetic energy from air currents (i.e., wind) acting on turbine blade assemblies 106 cause the turbine blade assemblies to impart rotational motion to second body portion 118 of the turbine body. As such, the turbine blade assemblies together with the second body portion of the turbine body rotate about axis AX2, as indicated by arrows RT1 and RT2 in FIG. 1.

Turbine blade assemblies 106 extend radially-outwardly from second body portion 116 between a first or proximal end 120 and a second or distal end 122. A longitudinal axis AX3 extends generally between the proximal and distal ends. In one preferred embodiment, the turbine blade assemblies are supported on second body portion 116 for rotation about axis AX3 respectively of each turbine blade assembly, as is generally indicated by arrows RT3 in FIG. 1. Rotation of the turbine blade assemblies about axes AX3 permits favorable orientation of the turbine blade assemblies with respect to the direction of the wind, as is well understood by those of skill in the art. Additionally, it will be appreciated that any suitable arrangement and/or control system can be used to selectively adjust the orientation of the turbine blade assemblies about axes AX3.

It will be recognized that turbine blades of a wide variety of different sizes, shapes, configurations and constructions have been developed, and that all such variations could not be shown and/or described in the subject disclosure. For example, turbine blades have been developed that include straight edges, tapered edges, curved edges, approximately planar sides, curved sides, symmetrically-shaped sides and asymmetrically-shaped sides. Additionally, many blades are twisted along the longitudinal length thereof such that the wind contacts the turbine blade at different angles at different points along the longitudinal extent of the turbine blade. Notwithstanding all of the many variations of turbine blades, it is to be understood that the subject matter of the present disclosure is broadly capable of use on or otherwise in association with turbine blades of any suitable type, kind, configuration and/or construction. As such, it is to be understood that the type, kind, size, shape, construction, configuration and/or arrangement of turbine blades shown and described herein are merely exemplary and not intended to be limiting.

A turbine blade assembly in accordance with the subject matter of the present disclosure, such as one of turbine blade assemblies 106, for example, includes a turbine blade and at least one surface that is disposed along at least one side of the turbine blade and is moveable relative to the side of the blade such that the relative speed of the moveable surface with respect to the wind is different than the relative speed of the side of the turbine blade would be at that same longitudinal location. In FIGS. 1 and 2, turbine blade assemblies 106 include a turbine blade 124 and a surface (schematically represented by shaded area 126) that extends along at least one side of turbine blade 124 and is moveable in a direction along the at least one side that is approximately transverse (e.g., perpendicular) to longitudinal axis AX3, as is represented by arrows AR1. For purposes of clarity and ease of understanding, a direction approximately transverse (e.g., perpendicular) to longitudinal axis Ax3 may also be referred to herein as a lateral direction.

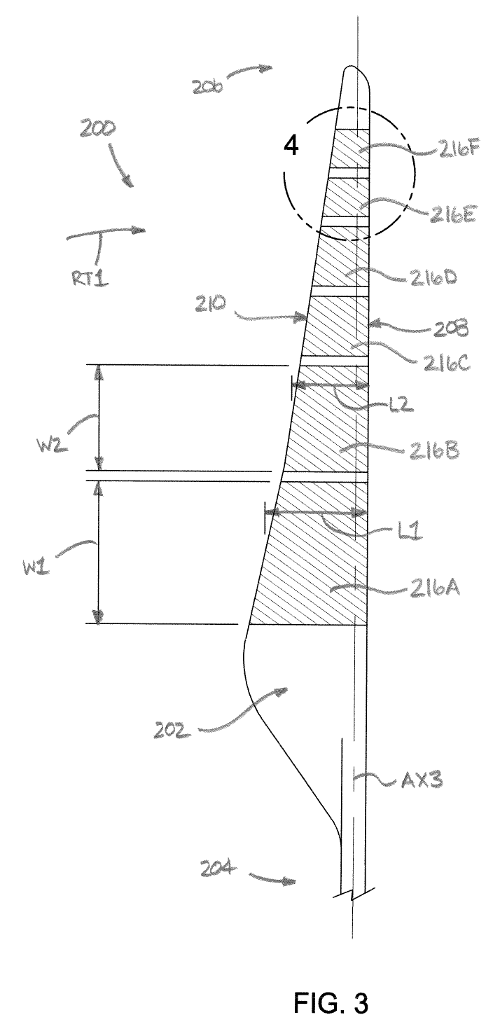

Turning, now, to FIGS. 3-5, one example of a turbine blade assembly 200 that is suitable for use as a turbine blade assembly in accordance with the subject matter of the present disclosure, such as turbine blade assemblies 106 in FIGS. 1 and 2, for example, is shown as including a turbine blade 202 that extends longitudinally between a first or proximal end 204 and a second or distal end 206 such that longitudinal axis Ax3 extends generally therebetween. Turbine blade 202 also includes a first or leading edge 208 that extends longitudinally along the turbine blade and a second or trailing edge 210 that extends longitudinally along the turbine blade in laterally-spaced relation to the leading edge. As can be observed from FIGS. 3-5, trailing edge 210 is shown as being disposed at an angle relative to leading edge 208, such a portion of the turbine blade nearer to distal end 206 will have a lesser lateral dimension than a portion of the turbine blade nearer to proximal end 204. As one example, such an arrangement could be due to the turbine blade being tapered in the lateral direction or, as another example, due to the turbine blade being twisted along the longitudinal length thereof.

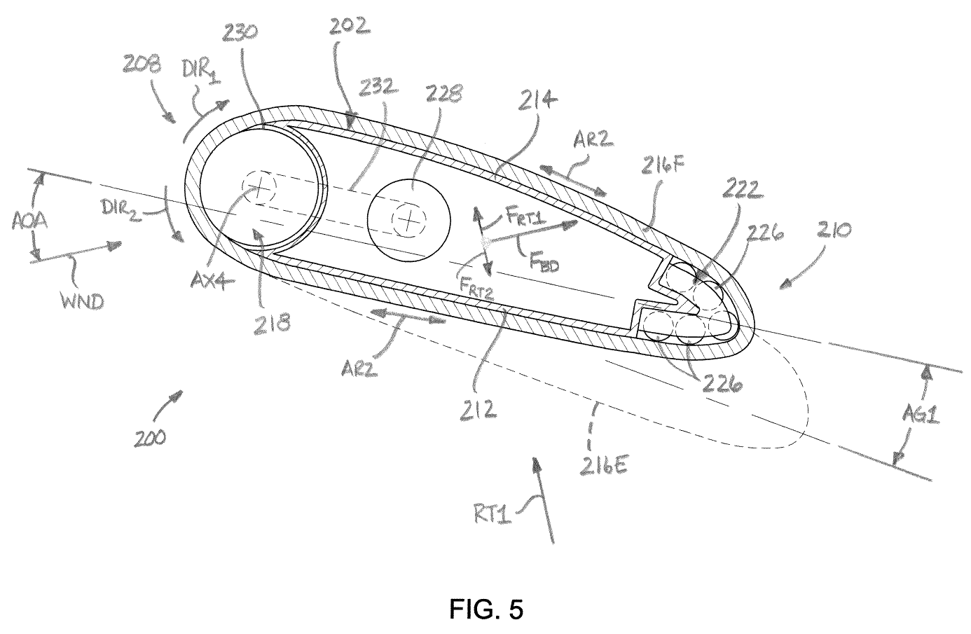

Turbine blade 202 further includes opposing first and second sides 212 and 214 (FIG. 5) that extend laterally between the leading and trailing edges of the turbine blade. Depending upon factors such as the shape of the turbine blade, the direction of rotation of the turbine blade about axis AX2 and the angle at which the turbine blade is disposed about axis AX3, one of the first and second sides of the turbine blade may be referred to as a pressure side with the other of the first and second sides being referred to as the suction side of the turbine blade. As will be discussed in greater detail hereinafter, first side 212 could operate as the pressure side of turbine blade 202 and second side 214 would operate as the suction side of the turbine blade.

As mentioned above, a turbine blade assembly in accordance with the subject matter of the present disclosure includes at least one surface that is moveable in an approximately lateral direction along a side of the turbine blade. It will be appreciated that any suitable number of one or more moveable surfaces can be used, such as from one (1) to fifty (50) different surfaces, for example. Additionally, it will be appreciated that the at least one moveable surface can take any suitable form, configuration and/or construction and can be of any suitable size and/or shape that may be cooperative with the turbine blade on which the at least one moveable surface is operatively supported. As one example, the at least one moveable surface can take the form of at least one endless band that is operatively supported on the turbine blade for movement in an approximately lateral direction along at least one side of the turbine blade.

In the exemplary embodiment shown in FIGS. 3-5, turbine blade assembly 200 includes a plurality of endless bands 216A-F that are supported on turbine blade 202 in longitudinally-spaced relation to one another. It will be appreciated that each of the plurality of bands can have one of two or more different widths, lengths and/or shapes. Due at least in part to the shape and/or configuration of turbine blade 202, the plurality of bands are shown in FIG. 3 as including a plurality of different widths and lengths. For example, band 216A has a nominal width W1 and an average length L1, and band 216B has a nominal width W2 that is less than width W1 and an average length L2 that is less than length L1. For purposes of clarity of illustration and ease of reading, the length and width dimensions are not shown for bands 216C-F. However, it will be appreciated that two or more of the plurality of bands can, optionally, have the same length and/or width dimensions. For example, bands 216C and 216D are shown as having approximately the same width as one another and bands 216E and 216F are also shown as having approximately the same width as one another.

It will be appreciated that the influence a given moving surface may have on a turbine blade will vary depending upon the position of the moving surface along the longitudinal length of the turbine blade. This is due, at least in part, to the increased distance from axis Ax2 at which force variations attributable to the moving surface will act on the turbine blade. In one exemplary embodiment of a turbine blade assembly, the one or more moving surfaces could be provided along only a portion of the longitudinal length of the turbine blade, such as along the outermost one-third of the blade, for example. As another exemplary embodiment of a turbine blade assembly, a plurality of moving surfaces could be spaced longitudinally along the turbine blade with one or more dimensions (e.g., length and/or width) of the moving surfaces decreasing in the direction of the distal end of the turbine blade.

If one or more endless bands are used to form the at least one moving surface on the turbine blade, as illustrated in FIGS. 3-5, for example, it will be appreciated that the one or more endless bands can be supported on the turbine blade in any suitable manner and can include any suitable components and/or devices for permitting the one or more endless bands to be conveyed along at least one side of the turbine blade. For example, one arrangement could utilize a first support element disposed toward the leading edge of the turbine blade and a second support element disposed in laterally-spaced relation to the first support element toward the trailing edge of the turbine blade. The one or more endless bands can then be supported between these laterally-spaced support elements.

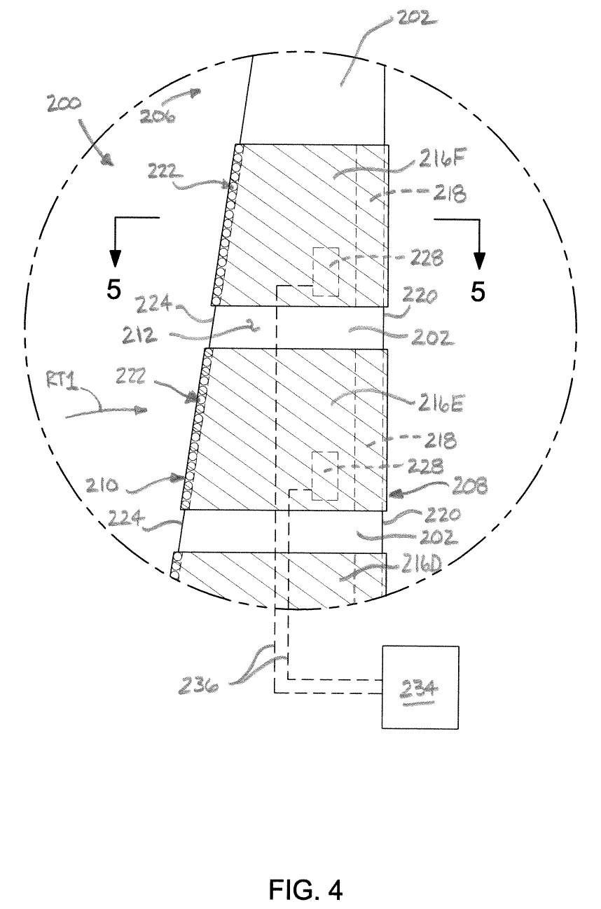

One exemplary arrangement is shown in greater detail in FIGS. 4 and 5 in which the first support element includes a roller 218 supported on turbine blade 202 for rotation about a longitudinally-extending axis AX4 (FIG. 5). Roller 218 can be supported on the turbine blade in any suitable manner, such as by using a pair of spaced-apart bearing elements (not shown), for example. Additionally, roller 218 can be supported in any suitable lateral position along turbine blade 202 toward the leading edge thereof. In the exemplary embodiment shown, roller 218 is supported in approximate alignment with fixed portions 220 of the turbine blade, which fixed portions at least partially form leading edge 208 together with rollers 218. For purposes of clarity of illustration and ease of understanding, rollers 218 are shown as being approximately cylindrical. However, it will be appreciated that any other configuration and/or arrangement could alternately be used, such as crowned rollers or tapered rollers, for example.

Another example of a support element that may be suitable for use in supporting an endless belt includes a plurality of bearing elements 222 spaced longitudinally along an edge of the turbine blade, such as along trailing edge 210, for example. In one exemplary arrangement, the plurality of bearing elements can be approximately aligned with fixed portions 224 of the turbine blade so that the plurality of bearing element together with the fixed portions at least partially form trailing edge 210. As one example, a plurality of wheels or roller elements could be longitudinally spaced along the leading or trailing edge of the turbine blade. Such a plurality of wheels or roller elements could rotate independently of one another to permit endless belts of a non-uniform length to be laterally conveyed about the turbine blade. As another example, plurality of bearing elements 222 can include one or more longitudinally-extending rows of spherical bearings 226 (i.e. ball bearings) that are suitably retained on the turbine blade, such as by using a ball bearing cage or other structure (not shown), for example.

The one or more endless bands (e.g., endless bands 216A-F) can be moved or otherwise conveyed along the one or more sides of the turbine blade in any suitable manner, such as by using one or more rotational motions sources operatively connected to the endless bands. As one example, a single drive shaft could extend longitudinally outwardly along the length of the turbine blade. The single drive shaft could be operatively connected to a drive element suitable for conveying the endless bands in a substantially synchronous manner. As another example, a plurality of motors or other rotational motion sources could be supported in longitudinally-spaced relation along the length of the turbine blade. Each of the plurality of motors could be operatively connected to a drive element suitable for conveying one or more of the endless bands. In such an arrangement, one or more of the endless bands could be independently controlled from the remaining one or more endless bands. As shown in FIGS. 4 and 5, an electric motor 228 can be operatively connected to each of rollers 218 for driving the same. Rollers 218 can be adapted to drivably engage one or more endless bands and convey or otherwise laterally move the one or more endless bands along at least one side of the turbine blade.

In the exemplary arrangement shown in FIGS. 4 and 5, endless band 216F drivably engaged by outer surface 230 of roller 218. Electric motor 228 is operatively connected to roller 218, such as by way of a suitable transmission element 232 (e.g., a transmission belt or gear set). By selectively operating electric motor 228, endless band 216F can be selectively moved with respect to first and second sides 212 and 214 of turbine blade 202, as indicated by arrows AR2. It will be appreciated that each of the one or more electric motors or other rotational motion sources can be controlled in any suitable manner. For example, electric motors 228 in FIG. 4 are shown as being in communication with a suitable control system 234, such as by way of communication lines 236, for example, that is adapted to selectively control the speed and direction of rotation of electric motors 228 to achieve a desired performance characteristic of the one or more surfaces (e.g., endless bands) driven thereby.

As indicated in FIG. 5, a turbine blade, such as turbine blade assembly 200, for example, is typically disposed at an angle with respect to the wind direction, as is indicated by angular reference dimension AOA relative to arrow WND. As discussed above, the angle of attack may vary along the longitudinal length of the turbine blade, such as where the turbine blade is of a twisted configuration. In such case, an adjacent endless band 216E may be disposed at an angle with respect to endless band 216F, as is indicated by angular reference dimension AG1. Though the angle of attack may vary due to the configuration of the turbine blade, the direction of rotation about axis AX2 (FIG. 2), which is represented in FIG. 5 by arrow RT1, is generally transverse (e.g., perpendicular) to the wind direction.

In the exemplary arrangement shown in FIGS. 3-5, endless bands 216A-F extend peripherally about the full exterior of discrete longitudinal portions of the turbine blade. That is, endless bands are conveyed along first side 212, around one of leading edge 208 or trailing edge 210, along second side 214 and around the other of the leading or trailing edges and back to the first side in a substantially continuous manner.

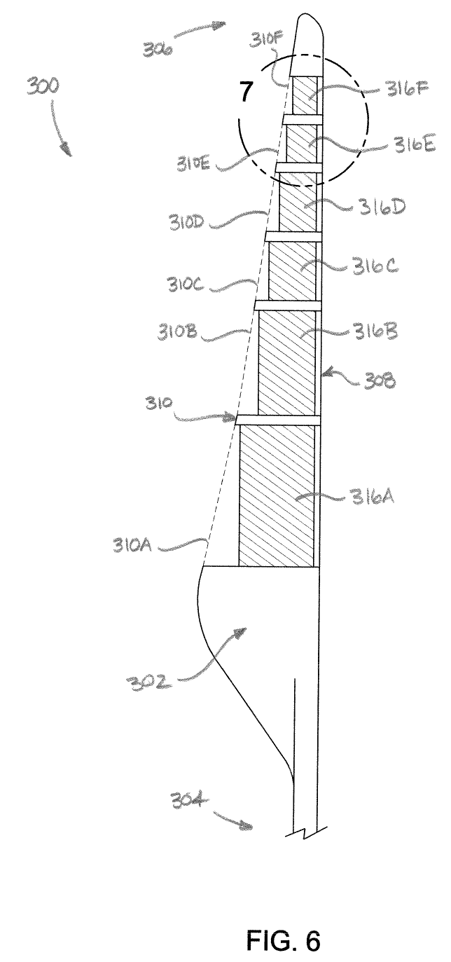

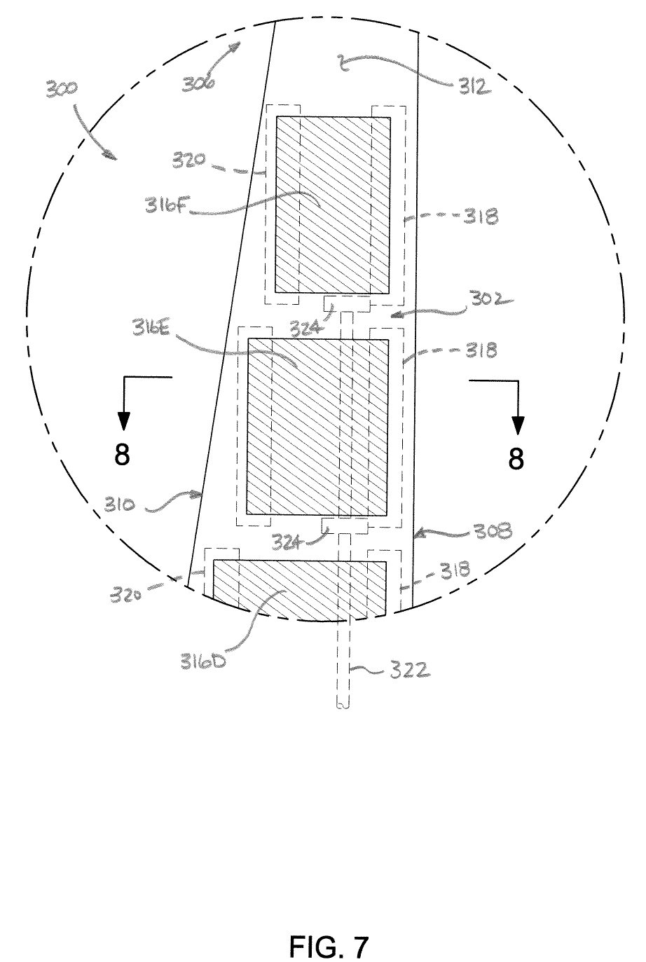

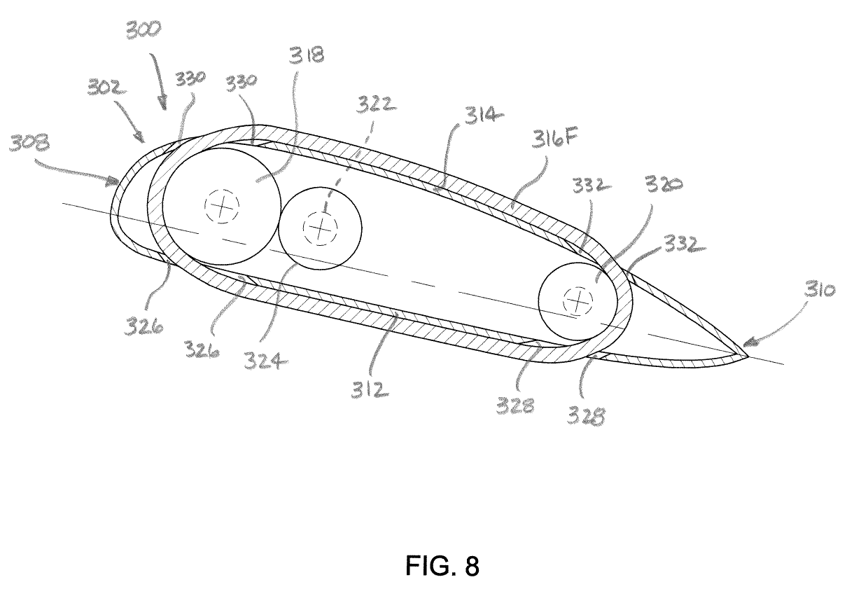

Another example of a turbine blade assembly 300 is shown in FIGS. 6-8 in which the moving surfaces only extend along the first and/or second sides of the turbine blade without extending about the leading and/or trailing edges thereof. Turbine blade assembly 300 includes a turbine blade 302 that extends longitudinally between a first or proximal end 304 and a second or distal end 306. Turbine blade 302 includes a leading edge 308 that extend longitudinally along the turbine blade and a trailing edge 310 that extends longitudinally along the turbine blade in laterally spaced relation to leading edge 308. Optionally, the turbine blade could include removable trailing edge sections 310A-F (FIG. 6) that could be removably secured on or along the turbine blade to provide access to the interior of the turbine blade, such as may be useful for maintenance and repair, for example. Turbine blade 302 also includes opposing first and second sides 312 and 314 (FIG. 8) that extend laterally between the leading and trailing edges.

Turbine blade assembly 300 also includes at least one surface that is moveable in an approximately lateral direction along a side of the turbine blade. As shown in the exemplary arrangement in FIGS. 6-8, turbine blade assembly includes a plurality of endless bands 316A-F disposed in longitudinally-spaced relation with respect to one another along the length of turbine blade 302. As discussed above with regard to endless bands 216A-F, endless bands 316A-F are shown as having one of two or more widths and lengths. Endless bands 316A-F differ from those shown in FIGS. 3-5 in that endless bands 316A-F are of an approximately uniform shape.

Endless bands 316A-F are shown extending between laterally spaced-apart support elements that permit the endless bands to be conveyed or otherwise moved with respect to one or more of the first and second sides of the turbine blade. As one example, the endless bands could be supported between rollers 318 and 320. Roller 318 drivably engaging the endless bands toward the leading edge of the turbine blade assembly and roller 320 being freely rotating to permit displacement of the endless band thereabout. It will be appreciated that cylindrical rollers, which are shown in FIGS. 6-8, may be used in conjunction with endless bands 316A-F, which are approximately uniformly-shaped. However, support elements of any other suitable shape and/or configuration could alternately be used in connection with other constructions and/or shapes of endless bands, such as crowned or tapered rollers, for example.

Rollers 318 or other support elements that may be suitable for drivably engaging one or more of endless bands 316A-F can be operatively connected to a rotational motion source in any suitable manner. As one example, one or more electric motors could be longitudinally spaced along the length of the turbine blade and operatively connected to one or more of the drive elements. As another example, a drive shaft 322 or other rotational motion source could extend longitudinally outwardly along the length of the turbine blade and be operatively connected to one or more of the drive elements (e.g., roller 318), such as by way of a suitable transmission element 324 (e.g., a transmission belt or gear set).

First side 312 of turbine blade 302 also includes first and second laterally-spaced openings 326 and 328. Similarly, second side 314 of the turbine blade includes first and second laterally-spaced openings 330 and 332. During operation, endless band 316F is conveyed around drive roller 318 and the first opening in one of the first and second sides, depending upon the direction in which the endless band is being displaced. The endless band is further displaced along the corresponding side of the turbine body and returns toward support roller 320 through the second opening in that first or second side. The endless band would continue to be displaced around support roller 320 and exit from the second opening in the opposing one of the first and second sides. The endless band is then further displaced along that opposing side toward the first opening therein through which the endless band returns to be drivably engaged by drive roller 318. It will be recognized that similar openings are provided along both sides of the longitudinal length of the turbine blade such that the one or more other endless bands can be similarly convey along at least a portion of the sides of the turbine blade.

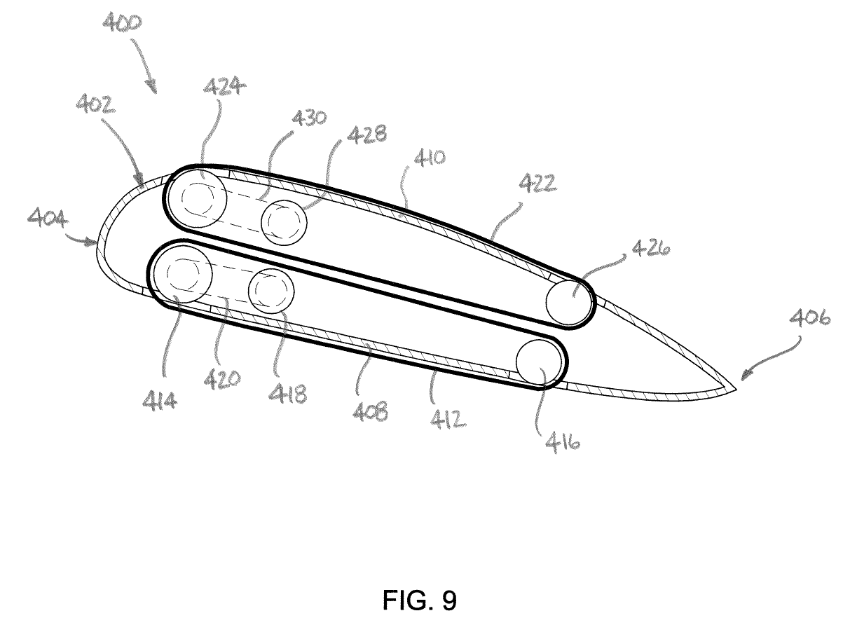

Additionally, or in the alternative, a turbine blade assembly, such as turbine blade assembly 106, 200 and/or 300, for example, can optionally include a first endless band operatively disposed along a first side of the turbine blade and a second endless belt that is operatively disposed along a second side of the turbine blade. FIG. 9 schematically represents a turbine blade assembly 400, such as has been described above, that includes a turbine blade 402 that has a first or leading edge 404 and a second or trailing edge 406 that is disposed in laterally spaced relation to the leading edge, such as has been previously described. Turbine blade 402 also includes a first side 408 that extends laterally between the leading and trailing edges, and a second side 410 that extends laterally between the leading and trailing edges generally opposite first side 410.

Turbine blade assembly 400 also includes a first endless band 412 operatively disposed for movement along first side 408. It will be appreciated that first endless band 412 can be supported between laterally-spaced support elements, such as rollers 414 and 416. Additionally, roller 414 can be operatively connected to a suitable rotational motion source 418 (e.g., an electric motor or drive shaft), such as by way of a suitable transmission element 420 (e.g., a transmission belt or gear set). First side 408 can be adapted to permit egress and return of endless band 412, such as has been discussed above with regard to first side 312, for example.

Turbine blade assembly 400 further includes a second endless band 422 that is operatively disposed for movement along second side 410 of turbine blade 402. Second endless band 422 can be similarly supported for movement between laterally-spaced support elements, such as rollers 424 and 426, for example. Roller 424 can be operatively connected to a suitable rotational motion source, such as rotational motion source 418 by way of a separate transmission element, for example. Alternately, roller 424 could be operatively connected to a separate rotational motion source 428 (e.g., an electric motor or drive shaft), such as by way of a suitable transmission element 430 (e.g., a transmission belt or gear set). Second side 410 can also be adapted to permit egress and return of endless belt 422, such as has been discussed above with regard to second side 314, for example.

Though not shown in the drawings, it will be appreciated that any suitable number of endless bands, such as from one (1) to fifty (50), for example, could be longitudinally-spaced along the first and/or second sides of a turbine blade. Additionally, it will be appreciated that any combination of quantity, width, length and/or configuration of endless bands could be used.

The at least one moveable surface operatively disposed on or along a turbine blade, such as one of endless bands 126, 216A-F, 316A-F, 412 and/or 422, for example, can be formed from any suitable material or combination of materials, such as metal, plastic and/or fabric, for example. Metal material could include stainless steel sheet, for example. Plastic material could include any suitable polymeric film, such as polyester film, for example. Fabric material could include any suitable elastomeric or non-elastomeric, woven or non-woven material having one or more plies formed of filaments of one or more types and/or kinds of material.

Reference is now made to the general operation and use of a turbine blade assembly in accordance with the subject matter of the present disclosure that includes a turbine blade and at least one moveable surface supported on or along at least one side of the turbine blade. As mentioned above, turbine blades are typically disposed at an angle relative to the wind direction. This angle is often referred to in the art as the angle of attack and is represented in FIG. 5 by angular reference dimension AOA, as has been previously discuss. As the air currents (i.e., wind) flow past the turbine blade, a force is generated on the turbine blade due to the pressure of the air current acting on the exposed side of the turbine blade. This force can be separated into a first directional component that acts in the direction of the wind and a second directional component that acts approximately transverse (e.g., perpendicular) to the first directional component. This second directional component can act to displace the turbine blade about the axis of rotation.

It will be appreciated, however, that in current turbine blade designs, forces attributable to or otherwise associated with the angle of attack represent only a portion of the overall forces acting on a turbine blade. Another portion of the overall forces acting on a turbine blade are attributable to the use of turbine blades having an airfoil design or cross-section. As is well understood in the art, air currents flowing past a turbine blade having an airfoil design will generate a first air pressure acting on one side and a second, different air pressure acting on the opposing side of the turbine blade. The generation of these two different air pressures is generally believed to be due to air flowing across the two different sides of the turbine blade at two different speeds, as is well understood in the art. Accordingly, the air flowing at a first speed (e.g., a higher speed) across one side of the turbine blade would be expected to generate a different pressure (e.g., a lower pressure) on the surface than the air flowing at a second speed (e.g., a lower speed) across the opposing side of the turbine blade (e.g., a higher pressure side). As a result, one side of the turbine blade is often referred to as the pressure side of the turbine blade with the opposing side being referred to as the suction side.

Forces due to differential air pressures acting on a turbine blade (i.e., aerodynamic forces other than those associated with the angle of attack) can also be resolved into a first directional component that acts in the direction of the wind and a second directional component that acts approximately transverse (e.g., perpendicular) to the first directional component. It is generally desirable to orient a turbine blade such that the portion of the force attributable to the angle of attack (i.e., the second directional component thereof) and the portion of the force attributable to differential air pressures (i.e., the second directional component thereof) are acting in the same direction to cause displacement of the turbine blade about the axis of rotation.

Generally, it will be appreciated that the at least one moveable surface supported on a turbine blade is capable of displacement in either of two lateral directions with respect to the side of the turbine blade. One such lateral direction will be approximately the same as the direction in which the air current (i.e., the wind) is flowing. The second lateral direction will be generally opposite the direction in which the air current (i.e., the wind) is flowing. Displacement of the at least one moveable surface along a side of a turbine blade will increase or decrease the overall force acting on the turbine blade depending upon which direction (i.e., with the wind or against the wind) the at least one moveable surface is being displaced. The change in the overall force acting on the turbine blade will also depend upon whether the at least one surface is being displaced along the pressure side, the suction side or both sides, and which direction the at least one surface is being displacement on that side (or along those sides).

As a more specific example, endless band 216F is shown in FIG. 5 as being capable of displacement in either of a first direction DIR₁ or a second direction DIR₂ at any one time. It will also be appreciated that endless band 216F extends along both of the first and second sides of turbine blade assembly 200 and that first side 212 will act as the pressure side and second side 214 will operate as the suction side, as has been described above. As endless band 216F is displaced in first direction DIR₁, the outer surface of the endless band will be displaced into air currents flowing along second or suction side 214 and the outer surface will be displace in a direction with the air currents flowing along first or pressure side 212. The displacement of the outer surface of an endless band in first direction DIR₁ is expected to generate an additional force acting on the turbine blade. Theories have not yet been developed to explain whether this additional force is a separate force acting on the turbine blade or whether this addition force is better characterized as an increase in the portion of the force acting on the turbine blade that is attributable to the differential air pressure between the opposing first and second surfaces.

For purposes of illustration and ease of understanding, the forces attributable to the operation of the one or more moveable surfaces are shown in FIG. 5 as being separated into directional components with a first directional force component being represented by arrow F_{BD} acting on the turbine blade in a direction approximately aligned with the wind direction, as indicated by arrow WND, and a second directional force component being represented by arrow F_{RT1} acting on the turbine blade in a direction promoting rotation about axis Ax2 (FIG. 2), as indicated by arrow RT1. It should be clearly understood that the force components represented by arrows F_{RT1} and F_{BD} will act together with the directional components of forces attributable to the angle of attack and the differential air pressure.

Due to the displacement of the surface of the endless belt in first direction DIR₁, the increase in force attributable to the displacement of the moveable surface, the portion of the force attributable to differential air pressures and the portion of the overall force attributable to the angle of attack are all acting in the same direction to cause displacement of the turbine blade about the axis of rotation. The increased force due to the sum of these directional components will generate a corresponding increase in torque at second body portion 118 (FIGS. 1 and 2). Such an increase in torque can be utilized to drive an electric generator 140, such as through a suitable transmission 142, for example, under wind speed conditions below a theoretical minimum wind speed threshold. Or, under normal operating conditions in which sufficient wind speed is present, such an increase in torque could be utilized to generate a corresponding increase in electrical output.

Additionally, it will be appreciated that the one or moveable surfaces can be selectively operated to vary the magnitude and/or direction of the additional force acting on the turbine blade. It will be recognized that the distal end of a conventional turbine blade moves at a greater instantaneous linear velocity than does the proximal end of the turbine blade. As one example, one or more of the endless bands (e.g., endless bands 216A-F, 316A-F, 412 and/or 422) could be operated at surface speeds that decrease with outward longitudinal position along the turbine blade, such as to balance the forces acting on the turbine blade, for example. As another example, one or more of the endless bands could be operated at surface speeds that increase with outward longitudinal position along the turbine blade, such as to offset any change in effective wind direction due to the movement of the turbine blade. As a further example, one or more of the endless bands could be selectively operated such that some bands are displaced and other bands remain stationary, such as to minimize maintenance and repair cost while obtaining benefits associated with the use of the one or more moveable surfaces.

Returning to the previous example, endless band 216F is also shown in FIG. 5 as being capable of displacement in second direction DIR₂. As endless band 216F is displaced in second direction DIR₂, the outer surface of the endless band will be displaced with the air currents flowing along first or pressure side 212 and the outer surface will be displace in a direction against the air currents flowing along second or suction side 214. The displacement of the outer surface of an endless band in first direction DIR₂ is expected to generate an additional force acting on the turbine blade. This additional force has a second directional force component, which is represented in FIG. 5 by arrow F_{RT2}, that acts on the turbine blade in a direction generally opposite of rotation about axis AX2 (FIG. 2), which is indicated by arrow RT1. Again, theories have not yet been developed to explain whether this additional force is a separate force acting on the turbine blade in the direction opposite rotation or whether this addition force is better characterized as an decrease in the portion of the force acting on the turbine blade that is attributable to the differential air pressure between the opposing first and second surfaces (i.e., aerodynamic forces other than those associated with the angle of attack). Nonetheless, the displacement of the at least one moveable surface in the second direction could be used to decrease the overall force being applied to the turbine blade in the direction of rotation, such as, for example, to permit operation of the wind turbine under wind speed conditions that would otherwise exceed a maximum wind speed threshold for conditions of operation of the wind turbine.

It will also be appreciated that first directional force component F_{BD}, which acts in the direction of the wind, can be accommodated in any suitable manner. As one example, the structure of a turbine blade, as well as the turbine body on which the turbine blade is supported, could simply be manufactured to be more robust to accommodate such increased load conditions. As another example, a blade support assembly or other structure could be provided to buttress the one or more turbine blade assemblies of the wind turbine. One example of a blade support assembly could include support structure that is operatively connected to the base structure and/or turbine body and a bearing structure that is supported on the support structure and is adapted to operatively engage the one or more turbine blade assemblies of the wind turbine.

In the arrangement shown in FIGS. 1 and 2, a blade support assembly 128 is shown as including a plurality of structural supports 130 that are attached to first portion 116 of turbine body 104. Blade support assembly 128 also includes a bearing structure 132 that is supported on structural supports 130 and is adapted to buttress turbine blade assemblies 106, such as under increased load conditions in the direction of wind WND that may result due to the operation of one or more moveable surfaces 126, for example.

Blade support assembly 128 can also, optionally, include one or more bearing elements that are supported on the one or more turbine blade assemblies and act to abuttingly engage the bearing structure and thereby minimize or at least reduce frictional losses between the bearing structure and the turbine blade assemblies, as the same rotate about axis AX2. The one or more bearing elements are schematically represented in FIG. 2 and identified by reference numbers 134. It will be appreciated that any suitable bearing elements could be used. As one example, a wheel (not shown) or roller (not shown) could be supported on the turbine blade for rotation about an axis dispose in approximate alignment with longitudinal axis AX3.

As another example, a magnetic bearing arrangement could be used to maintain the turbine blade assemblies in spaced relation to the bearing structure. In one exemplary arrangement, one or more magnets (not shown), such as permanent magnets and/or electromagnets, for example, could be supported on each of the turbine blade assemblies. A corresponding one or more magnets (not shown), such as permanent magnets and/or electromagnets, for example, could be disposed along bearing structure 132. In a preferred arrangement, at least the magnets disposed along the bearing structure are electromagnets that can be selectively operated by a suitable control system 136. Such a control system could be disposed in electrical communication with the electromagnets in any suitable manner, such as by way of electrical conductor 138, for example.

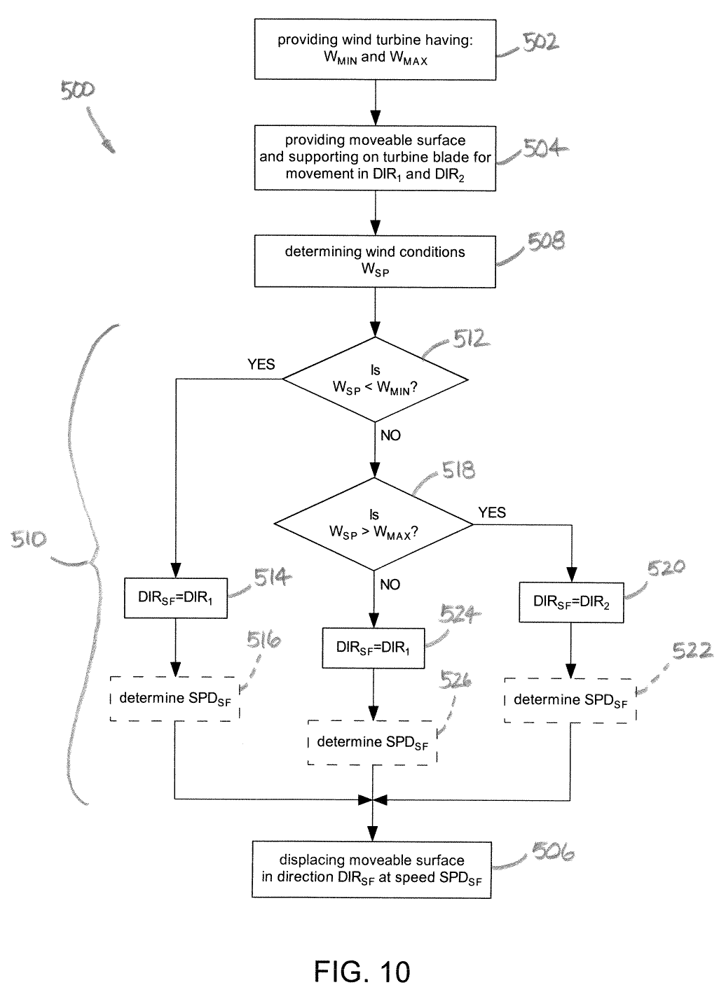

FIG. 10 illustrates on example of a method 500 of operating a wind turbine in accordance with the subject matter of the present disclosure. Method 500 includes providing a wind turbine, such as wind turbine 100, for example, that is operable above a theoretical minimum wind speed condition W_{MIN} and below a theoretical maximum wind speed condition W_{MAX}, as is represented by box 502 in FIG. 10. Method 500 also includes providing at least one moveable surface (e.g., one of endless bands 126, 216A-F, 316A-F, 412 and/or 422) and supporting the at least one moveable surface on a turbine blade of the wind turbine, as is represented by box 504 in FIG. 10. According to one preferred method, the at least one moveable surface will be displaceable in first and second lateral directions DIR₁ and DIR₂ with respect to at least one side of the turbine blade. It will be appreciated that the theoretical minimum and maximum wind speed conditions could be associated with a wind turbine of a substantially similar construction that does not include the at least one moveable surface. Alternately, the theoretical minimum and maximum wind speed conditions could be associated with a wind turbine on which the at least one moveable surface is not in operation.

Method 500 further includes displacing the at least one moveable surface in one of the first and second lateral directions DIR_{SF} and at a surface speed SPD_{SF}, as is represented by box 506 in FIG. 10. In one example of a simplified method of operation, such as is represented by boxes 502-506, for example, the at least one moveable surface on a turbine blade of a wind turbine could simply be displaced in a first pre-determined direction and at a first pre-determined surface speed regardless of the wind conditions that the wind turbine is experiencing. Optionally, method 500 can include additional actions that may assist in improving the efficiency, cost effectiveness and/or output of a wind turbine.

As such, method 500 can also, optionally, include determining the wind conditions under which the wind turbine will be operating, as is represented by box 508 in FIG. 10. Such an action, if performed, can include measuring, calculating or otherwise determining a wind speed condition W_{SP}, such as average wind speed, for example. Other conditions, such as maximum and/or minimum instantaneous wind speeds as well as wind direction, for example, could also, optionally, be determined. Method 500 can also, optionally, include determining suitable operating parameters for the at least one moveable surface operatively disposed along a turbine blade, as is indicated by reference number 510. Such an action, if performed, can include any suitable measurements, calculations and/or decisions that may be useful in determining an operating parameter for the at least one moveable surface. For example, such an action could include determining which direction to displace the at least one moveable surface with respect to the pressure and/or suctions side of the turbine blade. As another example, such an action could include determining an approximate speed at which the at least one moveable surface will be displaced.

One example of a plurality of actions that could be used to make a determination of operating parameters, as is represented by reference number 510, is shown in FIG. 10 as including an inquiry as to whether wind speed condition W_{SP} is less than theoretical minimum wind speed condition W_{MIN}, as is indicated in decision box 512. If a YES determination is made at box 512, the current wind speed conditions are below the theoretical minimum wind speed for operation of the wind turbine. In such case, direction of movement DIR_{SF} of the at least one surface is determined to be first direction DIR₁, as is represented by box 514. In a preferred arrangement, first direction DIR₁ will correspond to movement of the surface in a direction opposite the wind on the pressure side of a turbine blade and/or in a direction with the wind on the suction side of a turbine blade. As discussed above, this is expected to increase the force acting on the turbine blade, which may permit the wind turbine to operate under wind speed conditions below the theoretical minimum wind speed. Optionally, a determination of a suitable surface speed SPD_{SF} could also be made, as is represented by box 516. Thereafter, method 500 proceeds with displacement of the at least one moveable surface in the direction of movement and, optionally, at the surface speed that has been previously determined, as is indicated by box 506.

If a NO determination is made at box 512, however, the current wind speed conditions are above the theoretical minimum wind speed. As such, a further inquiry can be made as to whether wind speed condition W_{SP} is greater than the theoretical maximum wind speed condition W_{MAX}, as is indicated in decision box 518. IF a YES determination is made at box 518, the current wind speed conditions are above the theoretical maximum wind speed for operation of the wind turbine. In such case, direction of movement DIR_{SF} of the at least one surface is determined to be second direction DIR₂, as is represented by box 520. In a preferred arrangement, second direction DIR₂ will correspond to movement of the surface in a direction with the wind on the pressure side of a turbine blade and/or in a direction opposite the wind on the suction side of a turbine blade. As discussed above, this expected to decrease the force acting on the turbine blade, which may permit the wind turbine to operate under wind speed conditions above the theoretical maximum wind speed. Again, a determination of a suitable surface speed SPD_{SF} can optionally be made, as is represented by box 522. Thereafter, method 500 proceeds with displacement of the at least one moveable surface in the direction of movement and, optionally, at the surface speed that has been previously determined, as is indicated by box 506.

If a NO determination is made at box 518, the current wind speed conditions are within the desired range for operation of the wind turbine. In such case, direction of movement DIR_{SF} of the at least one surface is determined to be first direction DIR₁, as is represented by box 524. As described above, first direction DIR₁ will preferably correspond to movement of the surface in a direction opposite the wind on the pressure side of a turbine blade and/or in a direction with the wind on the suction side of a turbine blade. This is expected to increase the force acting on the turbine blade, which may permit the wind turbine to generate greater output or provide other desirable operational and/or performance characteristics. Optionally, a determination of a suitable surface speed SPD_{SF} could also be made, as is represented by box 526. Thereafter, method 500 proceeds with displacement of the at least one moveable surface in the direction of movement and, optionally, at the surface speed that has been previously determined, as is indicated by box 506.

While the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations insofar as they come within the scope of the appended claims and any equivalents thereof.

1. A wind turbine comprising:
a base structure;
a turbine body including first and second body portions, said first body portion supported on said base structure and including a first axis extending longitudinally along said first body portion, said second body portion supported on said first body portion for rotation about said first axis; and,
a turbine blade assembly supported on said second turbine body for rotation therewith about said first axis, said turbine blade assembly including:
a turbine blade having a longitudinal length, a first longitudinal edge, a second longitudinal edge spaced laterally from said first longitudinal edge, a first side extending longitudinally along at least a portion of said length between said first and second longitudinal edges, and a second side extending longitudinally along at least a portion of said length between said first and second longitudinal edges and generally opposite said first side, said blade including a proximal end operatively connected to said second turbine body and a distal end spaced radially-outwardly from said proximal end; and,
a first endless band including a first outer surface and a first band width, said first endless band oriented such that said first band width extends longitudinally along said blade, said first endless band supported on said blade such that said first outer surface is exposed along at least a portion of at least one of said first and second sides of said blade and is capable of lateral movement along said at least one of said first and second sides such that a relative velocity can be maintained between said first outer surface and said at least one of said first and second sides of said blade.

2. A wind turbine according to claim 1, wherein said wind turbine has a theoretical maximum wind speed for operation and during use under the influence of wind traveling at wind speeds less than or equal to said theoretical maximum in which said first longitudinal edge acts as a leading edge of said blade, said second longitudinal edge acts as a trailing edge of said blade, said first side operates as a pressure side of said blade and said second side operates as a suction side of said blade, said first endless band is displaced relative to said blade such that at least one of:
said first outer surface of said first endless band moves laterally along said first side of said blade in a direction extending from said trailing edge toward said leading edge; and,
said first outer surface of said first endless band moves laterally along said second side of said blade in a direction extending from said leading edge toward said trailing edge.

3. A wind turbine according to claim 2, wherein said turbine blade assembly includes:
a second endless band spaced longitudinally along said blade from said first endless band, said second endless band including a second outer surface and a second band width, said second endless band oriented such that said second band width extends longitudinally along said blade, said second endless band supported on said blade such that said second outer surface is exposed along at least a portion of at least one of said first and second sides of said blade and is capable of lateral movement along said at least one of said first and second sides; and,
said second endless band displaced relative to said blade such that at least one of:
said outer second surface of said second endless band moves laterally along said first side of said blade in a direction extending from said trailing edge toward said leading edge; and,
said second outer surface of said second endless band moves laterally along said second side of said blade in a direction extending from said leading edge toward said trailing edge.

4. A wind turbine according to claim 3, wherein said first outer surface of said first endless band moves at a first surface speed and said second outer surface of said second endless band moves at a second surface speed that is different from said first surface speed.

5. A wind turbine according to claim 4, wherein said second endless band is positioned toward said distal end with respect to said first endless band, and said second surface speed is less than said first surface speed.

6. A wind turbine according to claim 1, wherein said wind turbine has a theoretical maximum wind speed for operation and during use under the influence of wind traveling at wind speeds greater than said theoretical maximum in which said first longitudinal edge acts as a leading edge of said blade, said second longitudinal edge acts as a trailing edge of said blade, said first side operates as a pressure side of said blade and said second side operates as a suction side of said blade, said first endless band is displaced relative to said blade such that at least one of:
said outer surface of said first endless band moving laterally along said first side of said blade in a direction extending from said leading edge toward said trailing edge; and,
said outer surface of said first endless band moving laterally along said second side of said blade in a direction extending from said trailing edge toward said leading edge.

7. A wind turbine according to claim 6, wherein said turbine blade assembly includes:
a second endless band spaced longitudinally along said blade from said first endless band, said second endless band including a second outer surface and a second band width, said second endless band oriented such that said second band width extends longitudinally along said blade, said second endless band supported on said blade such that said second outer surface is exposed along at least a portion of at least one of said first and second sides of said blade and is capable of lateral movement along said at least one of said first and second sides; and,
said second endless band displaced relative to said blade such that at least one of:
said outer second surface of said second endless band moves laterally along said first side of said blade in a direction extending from said leading edge toward said trailing edge; and,
said second outer surface of said second endless band moves laterally along said second side of said blade in a direction extending from said trailing edge toward said leading edge.

8. A wind turbine according to claim 7, wherein said first outer surface of said first endless band moves at a first surface speed and said second outer surface of said second endless band moves at a second surface speed that is different from said first surface speed.

9. A wind turbine according to claim 8, wherein said second endless band is positioned toward said distal end with respect to said first endless band, and said second surface speed is greater than said first surface speed.

10.-14. (canceled)

15. A wind turbine according to claim 1, wherein said first outer surface of said first endless band is exposed along at least a portion of each of said first and second sides of said blade.

16.-22. (canceled)

23. A wind turbine blade assembly comprising:
a wind turbine blade including a longitudinal length extending between opposing first and second ends, a first edge extending longitudinally along said blade, a second edge extending longitudinally along said blade in laterally spaced relation to said first edge, a first side extending longitudinally along said blade and laterally between said first and second edges, and a second side extending longitudinally along said blade and laterally between said first and second edges generally opposite said first side; and,
a first endless band including a first outer surface and a first band width, said first endless band oriented such that said first band width extends longitudinally along said blade, said first endless band supported on said blade such that said first outer surface is exposed along at least a portion of at least one of said first and second sides of said blade and is capable of lateral movement along said at least one of said first and second sides such that a first relative velocity can be maintained between said first outer surface and said at least one of said first and second sides of said blade.

24. A wind turbine blade assembly according to claim 23 further comprising a second endless band that includes a second outer surface and a second band width, said second endless band disposed in longitudinally-spaced relation to said first endless band and oriented such that said second band width extends longitudinally along said blade, said second endless band supported on said blade such that said second outer surface is exposed along at least a portion of at least one of said first and second sides of said blade and is capable of lateral movement along said at least one of said first and second sides such that a second relative velocity can be maintained between said second outer surface and said at least one of said first and second sides of said blade.

25. A wind turbine blade assembly according to claim 24, wherein said first band has a first length and said second band has a second length that is different from said first length.

26.-30. (canceled)

31. A wind turbine blade assembly according to claim 23 further comprising a second endless band that includes a second outer surface and a second band width;
said first endless band supported on said blade such that said first outer surface is exposed along at least a portion of said first side of said blade and is capable of lateral displacement therealong; and,
said second endless band oriented such that said second band width extends longitudinally along said blade, and said second endless band supported on said blade such that said second outer surface is exposed along at least a portion of said second side of said blade and is capable of lateral displacement therealong and such that a second relative velocity can be maintained between said second outer surface and said second side of said blade.

32.-40. (canceled)

41. A wind turbine blade assembly according to claim 23, wherein said first endless band is one of a plurality of endless bands supported along said longitudinal length of said blade, said plurality of endless bands including from two (2) to fifty (50) endless bands.

42.-43. (canceled)

44. A method of operating a wind turbine, said method comprising:
a) providing a wind turbine that includes a base structure, a turbine body supported on said base structure and having a longitudinal-extending turbine body axis, and at least one turbine blade supported on said turbine body for rotation about said turbine body axis, said at least one turbine blade including a longitudinal length extending between opposing first and second ends, a first edge extending longitudinally along said blade, a second edge extending longitudinally along said blade in laterally spaced relation to said first edge, a first side extending longitudinally along said blade and laterally between said first and second edges, and a second side extending longitudinally along said blade and laterally between said first and second edges generally opposite said first side;
b) providing an endless band including a first outer surface and a first band width, orienting said endless band such that said first band width extends longitudinally along said blade, and supporting said endless band on said blade such that said first outer surface is exposed along at least a portion of at least one of said first and second sides of said blade; and,
c) driving said at least one endless band such that said outer surface moves laterally along at least one of said first and second sides of said blade between said first and second edges thereof.

45. A method according to claim 44, wherein providing at least one endless band in b) includes providing a plurality of bands spaced apart from one another along said longitudinal length of said blade, and driving said at least one band in c) includes driving said plurality of band such that said outer surface thereof moves along at least one of said first and second sides of said blade between said first and second edges thereof.

46. (canceled)

47. A method according to claim 45, wherein driving said plurality of bands includes driving at least one of said plurality of bands at a first surface speed and at least one of plurality of bands at a second surface speed that is different from said first speed.

48. A method according to claim 44, wherein providing an endless band in a) includes providing a first endless band supported on said blade such that said first outer surface is exposed along said first side of said blade and providing a second endless band that includes a second outer surface and a second band width, and supporting said second endless band on said blade such that said second outer surface is exposed along said second side of said blade, and driving in c) includes driving said first endless band such that said first outer surface moves along said first side of said blade in a first direction and driving said second endless band such that said second outer surface moves along said second side of said blade in a second direction opposite said first direction.

49. A method according to claim 44, wherein said wind turbine has a theoretical maximum wind speed for operation and said wind turbine is in use under the influence of wind traveling at wind speeds less than or equal to said theoretical maximum during which said first longitudinal edge acts as a leading edge of said blade, said second longitudinal edge acts as a trailing edge of said blade, said first side operates as a pressure side of said blade and said second side operates as a suction side of said blade, and driving said endless band in c) includes at least one of:
driving said endless band such that said first outer surface thereof moves laterally along said first side of said blade in a direction extending from said trailing edge toward said leading edge; and,
driving said endless band such that said first outer surface thereof moves laterally along said second side of said blade in a direction extending from said leading edge toward said trailing edge.

50. A method according to claim 44, wherein said wind turbine has a theoretical maximum wind speed for operation and said wind turbine is in use under the influence of wind traveling at wind speeds greater than said theoretical maximum during which said first longitudinal edge acts as a leading edge of said blade, said second longitudinal edge acts as a trailing edge of said blade, said first side operates as a pressure side of said blade and said second side operates as a suction side of said blade, and driving said endless band in c) includes at least one of:
driving said endless band such that said first outer surface thereof moves laterally along said first side of said blade in a direction extending from said leading edge toward said trailing edge; and,
driving said endless band such that said first outer surface thereof moves laterally along said second side of said blade in a direction extending from said trailing edge toward said leading edge.

51. A method according to claim 44, wherein said wind turbine has a theoretical minimum wind speed for operation and said wind turbine is in use under the influence of wind traveling at wind speeds less than said theoretical minimum during which said first longitudinal edge acts as a leading edge of said blade, said second longitudinal edge acts as a trailing edge of said blade, said first side operates as a pressure side of said blade and said second side operates as a suction side of said blade, and driving said endless band in c) includes at least one of:
driving said endless band such that said first outer surface thereof moves laterally along said first side of said blade in a direction extending from said trailing edge toward said leading edge; and,
driving said endless band such that said first outer surface thereof moves laterally along said second side of said blade in a direction extending from said leading edge toward said trailing edge.
